(19) United States
(12) Patent Application Publication
(10) Pub. No.: US 2012/0209890 A1
(43) Pub. Date: Aug. 16, 2012

(54) INTER-ENTERPRISE INGREDIENT SPECIFICATION COMPLIANCE

(75) Inventors: Gary Nowacki, Exeter, NH (US); Andrew J. Dolan, Arvada, CO (US); William R. Pape, Sante Fe, NM (US)

(73) Assignee: AGINFOLINK HOLDINGS INC., A BVI CORPORATION, Tortola (VG)

(21) Appl. No.: 13/372,586

(22) Filed: Feb. 14, 2012

Related U.S. Application Data
(60) Provisional application No. 61/442,473, filed on Feb. 14, 2011.

(51) Int. Cl. G06F 17/30

(52) U.S. Cl. 707/805; 707/E17.005

(57) ABSTRACT

Methods, systems, and apparatus, including computer programs encoded on computer storage media, for evaluating inter-enterprise ingredient specification compliance. In one aspect, a method includes obtaining one or more normalized values that reflect an extent to which a supplier entity has satisfied an expectation of a receiver entity, populating a global ingredient database that references different ingredients, and different supplier entities and attributes associated with each ingredient, with the normalized values, receiving a user's selection of an ingredient, a supplier entity, or an attribute, aggregating one or more of the normalized values that are associated with the selected ingredient, supplier entity, or attribute in the global ingredient database, and outputting a representation of the aggregated values to the user.

### CROSS-REFERENCE TO RELATED APPLICATION

This application claims the benefit of U.S. Provisional Pat. App. No. 61/442,473, filed Feb. 14, 2011, which is incorporated herein by reference.

### BACKGROUND

This specification relates to supply chain management.

Many enterprises process ingredients into finished products. When an enterprise begins using a new ingredient and is thus “naïve” to the ingredient, there are very few ways for the enterprise to objectively evaluate the performance, credibility, and reliability of a potential supplier of the ingredient. For instance, enterprises may completely rely on subjective variables, such as promises from the potential supplier or opinions rendered on the potential supplier by others, when entering into a business relationship with a potential supplier.

### SUMMARY

According to one innovative aspect of the subject matter described by this specification, a global ingredient database collects normalized data from multiple customers (or “receiver entities”) of a supplier (or “supplier entity”), to create a global risk or favorability profile for suppliers across ingredients and attributes of ingredients. In doing so, a customer can objectively measure the strengths and weaknesses of a particular supplier based on past interactions between the particular supplier and other customers, without relying on subjective information, and without revealing to the customer information that may be proprietary or sensitive to the other customers. Such an approach may be particularly useful for enterprises that are naïve to an ingredient, and have little or no exposure to particular suppliers, ingredients, or ingredient attributes.

According to one innovative aspect of the subject matter described by this specification, a method includes obtaining one or more normalized values that reflect an extent to which a supplier entity has satisfied an expectation of a receiver entity, populating a global ingredient database that references different ingredients, and different supplier entities and attributes associated with each ingredient, with the normalized values, receiving a user's selection of an ingredient, a supplier entity, or an attribute, aggregating one or more of the normalized values that are associated with the selected ingredient, supplier entity, or attribute in the global ingredient database, and outputting a representation of the aggregated values to the user.

Other embodiments of these aspects include corresponding systems, apparatus, and computer programs, configured to perform the actions of the methods, encoded on computer storage devices.

These and other embodiments may each optionally include one or more of the following features. For instance, the normalized values reflect an extent to which the supplier entity has deviated from a specification value; each normalized value reflects an extent to which the supplier entity has deviated from a specification value for an attribute of the ingredient; the normalized values reflect an extent to which the supplier entity's reported values match third party assessed values; the normalized values reflect an extent to which the supplier entity has satisfied on-time information requests from the receiver entity; the method includes receiving one or more actual values and one or more expected values, and generating the one or more normalized values using the actual values and the expected values; the user comprises the receiver entity; the user is a different receiver entity with which the supplier entity does not have an existing business relationship; the user is the supplier entity; the user is a competitor of the supplier entity; and/or the user is a third party that is not the supplier entity or a competitor of the supplier entity, and is not the receiver entity.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIGS. 1, 5, 7 and 8 are diagrams of example systems.

FIGS. 2 and 9 are example flowcharts.

FIG. 3 depicts an example certificate of analysis.

FIG. 4 is an example screenshot.

FIG. 6 shows an example of the calculation of risk scores for a sample shipment of an ingredient.

FIG. 10 provides an snapshot of the example contents of a global ingredient database.

FIG. 11 illustrates several example relationships between customers and suppliers of an ingredient.

Like reference symbols in the various drawings indicate like elements.

### DETAILED DESCRIPTION

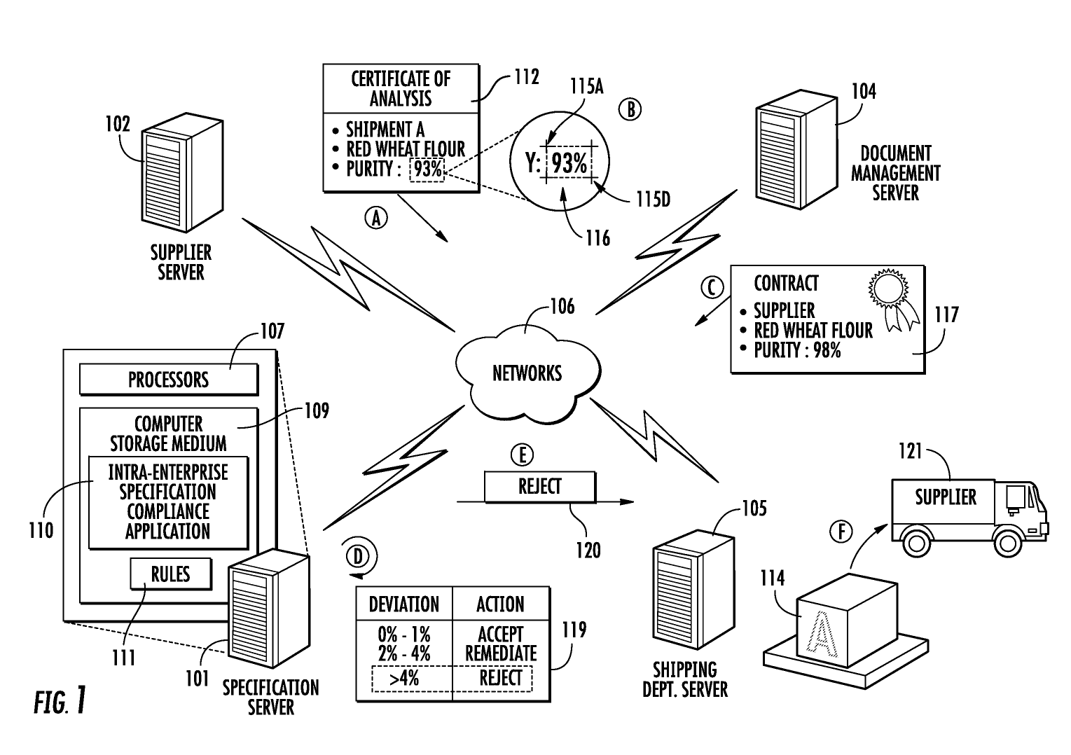

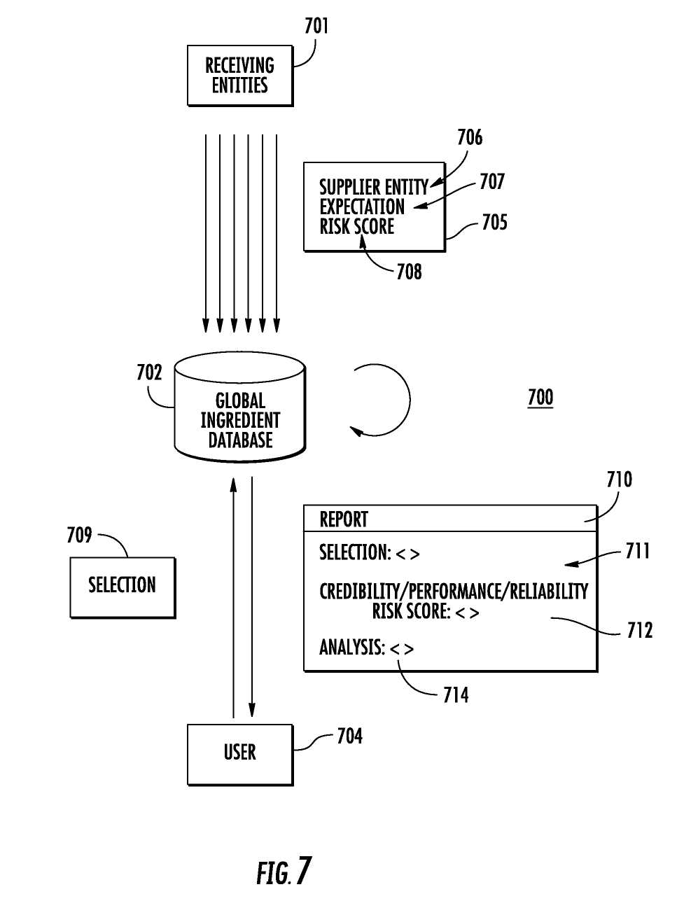

In general, FIGS. 1 to 6 describe corresponding systems, apparatus, and computer programs for performing intra-enterprise specification compliance, while FIGS. 7 to 10 describe corresponding systems, apparatus, and computer programs for performing inter-enterprise specification compliance.

With respect to intra-enterprise specification compliance (FIGS. 1 to 6), an enterprise can automatically analyze a certificate of analysis for a shipment of an ingredient before or after the shipment is received, to identify different quality or purity attributes associated with the ingredient in the shipment, and values associated with the identified attributes. This specification refers to the values that are automatically identified from a certificate of analysis as “certified values” or “certified attribute values.”

The certified values are compared to a specification that specifies attribute values that the enterprise requires to process the ingredient into a finished product. In some cases, the specification specifies attribute values that a supplier of the ingredient has contracted, promised or otherwise committed to provide in the shipment to the enterprise. This comparison may allow the enterprise to determine the extent to which the shipment satisfies or deviates from the specification and, by extension, the extent to which the supplier has honored or failed to live up to their commitments.

Depending on the nature or extent of any deviations between received attribute values and promised or required specification values, various actions may be taken on the shipment, or on future shipments from the supplier. In one example, a shipment of an ingredient that includes a certified value that significantly deviates from a specification value may be automatically returned to the supplier, before or after the shipment has arrived at the enterprise. Alternatively, a shipment of an ingredient that significantly deviates from specification values may be blended in with other shipments of the ingredient that comply with the specification values. Deviations between certified values and specification values may also be used to calculate risk scores that are specific to the supplier, the ingredient, the shipment, the attribute, or any combination thereof. Small deviations, or a lack of deviation, can trigger actions that benefit suppliers, such as by accepting shipments, triggering bonus payments, expediting processing of invoices, or posting positive reviews or accolades for the supplier.

In some aspects, comparison of the certified values with actual attribute values that may be measured or generated by the enterprise may allow the enterprise to determine the extent to which the supplier-provided certificate of analysis is accurate. Such an analysis allows the enterprise to aggregate data across multiple suppliers, shipments, ingredients and attributes to generate a so-called “liars report” that measures the accuracy of the certified statements of various suppliers. Such a report may identify those suppliers, for instance, that overstate the attributes of the ingredients that they supply.

With respect to inter-enterprise specification compliance (FIGS. 7 to 10), a global ingredient database collects normalized data, e.g., the risk scores calculated by multiple receiver entities of a supplier entity using respective intra-enterprise specification compliance processes, to create a global risk or favorability profile for supplier entities across ingredients and attributes of ingredients. In doing so, a receiver entity can objectively measure the strengths and weaknesses of a particular supplier entity based on past interactions between the particular supplier and other receiver entities, without relying on subjective information, and without revealing to the information that may be proprietary or sensitive to the other receiver entities. Such an approach may be particularly useful for enterprises that are naïve to an ingredient, and have little or no exposure to particular suppliers, ingredients, or ingredient attributes.

As used by this specification, an “ingredient” refers to a substance that forms part of a mixture or finished product, such as an agricultural product, food item, or packaging material. Certain ingredients may have attributes that exhibit variability. Example ingredients may include grains or particular types of grains, such as wheat flour. Other ingredients may include proteins, meat products, water, grains, lard, eggs, milk, syrups (such as corn syrups), sugar, spices, artificial or natural additives, or other substances. The ingredients may be “first mile,” raw ingredients, or processed or partially processed ingredients.

“Attributes” of an ingredient (or “ingredient attributes”) refer to a quality, character, characteristic or property of the ingredient, and may include, among others, a moisture content attribute, a pH attribute, a color attribute, a condition attribute, a date attribute, an appearance attribute, an odor or taste attribute, an age attribute, a count attribute, an age attribute, a calorie attribute, a supplier name attribute, a source attribute, a microbiological test attribute (such as for the existence of pathogens), a debris free attribute, or a derived attribute that is determined or calculated based the multiple discrete attributes. For instance, a “saleability” derived attribute may be based on multiple different attributes that, in combination, indicate or suggest whether an ingredient is suitable for sale.

Attributes are associated with values that quantify an amount, quantity, or level of the attribute that occurs in a particular shipment of an ingredient. The attributes included on a certificate of analysis may be chosen by the supplier or by the enterprise. These values, referred to simply as “values,” or as “attribute values,” are certified by the supplier of the ingredient or their agent. Attribute values are specific to a particular shipment, and thus different shipments have different certificates of analysis that may show different attribute values.

A “specification” is an explicit set of requirements that is to be satisfied by a material, product, or service, as provided, for example, in a document such as a contract or a shipping invoice. The specification can specify values for different attributes that are to be satisfied, where these values are referred to as “specification values.” As used herein, a “shipment” refers to a quantity of a good, such as an ingredient, that are shipped together as part of a same batch or lot. A single shipment may include multiple parts that are shipped at the same or at different times.

A “normalized value” is a value that has been processed in a way that makes it possible to be efficiently compared against other values. A normalized value may be processed, for example, to converting values which may have multiple representations into a common form, or to convert values to within a predefined range. Furthermore, a normalized value may be processed to remove or flag values that are outside of an expected range, for example to remove null values, or impossible values (e.g., a pH of “37”), or to invoke additional processes (such a process to manually verify a supplier-specific certificate of analysis template) when these values are detected.

One benefit to normalization is that, in obscuring actual values, it may be difficult or impossible to trace back a normalized value to its source, e.g., to a particular shipping entity, receiver entity, or shipment, providing anonymity to an entity that shares a normalized value with others. For instance, a receiver entity that receives a very large quantity of an ingredient and a receiver entity that receives a very small quantity of an ingredient may both supply normalized values (or values that may be used to calculate normalized values) with a global ingredient database.

In doing so, an entity that views the normalized value, such as the supplier, will not be able to positively identify the source of the normalized values, even though the quantities of each respective shipment may be quite different. Such an approach encourages receiver entities to share information that may be useful to others in evaluating various ingredients and supplier entities. Additionally, by using normalized values, customers that only use small amounts of an ingredient are encouraged to provide feedback on particular suppliers, since the normalized values that they supply may carry the same weight as normalized values supplied by customers that use vastly greater amounts of the ingredient.

Furthermore, “intra-enterprise” specification compliance relates to compliance testing that is performed by an enterprise using the enterprise's own data relating to operational characteristics of a supplier, as well as publically available data such as industry standard data. Said another way, intra-enterprise specification compliance does not require that supplier performance data be shared between enterprises. “Inter-enterprise” specification compliance relates to compliance testing that is performed by an enterprise using normalized data from multiple enterprises, which may or may not include normalized data from the enterprise itself. By normalizing supplier performance data, inter-enterprise specification compliance The normalized data used for performing inter-enterprise specification compliance may come from a global ingredient database with stores normalized data relating to suppliers, ingredients, shipments and/or attributes on behalf of multiple enterprises.

FIG. 1 is a diagram of an example system 100 for performing intra-enterprise specification compliance. The system 100 includes a specification compliance server 101, a document management server 104, and a shipment management server 105, all of which are accessible by an enterprise (referred to as “the enterprise” or “the recipient”) that is expecting to receive, is receiving, or has received a shipment. For example, the specification compliance server 101 may be used by the enterprise's quality assurance department, the document management server 104 may be used by the enterprise's legal department, and the shipment management server 105 may be used by the enterprise's shipping and receiving department.

The specification compliance server 101, the document management server 104, and the shipment department server 105 may be implemented on different servers, or the functionality of two or more of these servers can be combined on a single server or server system. Any one or more of these servers may be under the control of the enterprise itself, or they may be accessible to the enterprise over the networks 106. For instance, the specification compliance server 101, the document management server 104, and the shipment department server 105 may actually be servers that are controlled by a third party, and that host specification compliance software that is accessible to the enterprise under a “Software as a Service” (“SaaS”) subscription. In another example implementation, the specification compliance server 101, the document management server 104 and the shipment department server 105 may represent three different interfaces provided by the same server.

The system 100 also includes a supplier server 102 that is under the control of, or otherwise accessible to, a supplier of the shipment 114 of an ingredient, or of an agent of the supplier. Example agents may include independent testing agencies or laboratories, agencies that process certificates of analysis or compliance on behalf of the supplier, or shipping companies. The supplier server 102 obtains or generates certificates of analysis or, where certificates of analysis are not exchanged between the supplier and the enterprise, the supplier provides a data exchange service (e.g., a web service or portal) that allows the enterprise to access attribute values for a shipment 114. The supplier may be an immediate or direct supplier of the enterprise, or an indirect supplier.

Each of the specification compliance server 101, the supplier server 102, the document management server 104, and the shipment management server 105 may be a computing device, such as a server, a desktop or laptop computer, a tablet computer, a music player, an e-book reader, a consumer electronic product, an embedded system, or any other device that includes one or more computer processors and computer-readable storage media. Any one or more of the servers may instead represent an interface to a device or server that may or may not be under the control of the supplier or the enterprise. The servers 101 to 104 are in communication with each other over one or more networks 106. The networks 106 may include public computer networks, such as the Internet, private computer networks, such as corporate intranets, or any appropriate combination thereof.

The specification compliance server 101 includes one or more computer processors 107 and computer readable storage medium 109, upon which the specification compliance server 101 stores an intra-enterprise specification compliance application 110 and one or more sets of rules 111. The other servers may include similar hardware. Among other functions, the intra-enterprise specification compliance application implements the processes illustrated in FIG. 1 for determining the extent to which the shipment 114 satisfies or deviates from a specification, for initiating action on the shipment, and for calculating risk scores for suppliers, ingredients, shipments, and/or attributes. In addition to or instead of calculating risk scores, favorability scores can also be calculated to reflect an extent to which suppliers have met or satisfied expectations.

FIG. 1 also illustrates an exemplary flow of data through the system 100 during states (a) through (f). The states (a) through (f) may occur in the illustrated sequence, or they may occur in a sequence that is different than is illustrated. During state (a), the supplier provides the enterprise with certificate of analysis 112, or provides the enterprise with access to information that is included on a certificate of analysis.

The certificate of analysis 112 may be a physical document, i.e., on paper, or the certificate of analysis 112 may be an electronic document, i.e., a computer file such as a plaintext file, an eXtensible Markup Language (XML) file, a Portable Document Format (PDF) file, a markup language file, a comma separated value (CSV) file, or a word processor or spreadsheet file. The certificate of analysis 112 may be provided to the enterprise before, with, or after the delivery or attempted delivery of the shipment 114. For example, the certificate of analysis 112 may be stapled to the shipment 114 itself when the shipment is received by the enterprise, or may be provided to the enterprise electronically beforehand. For instance, the supplier may include a Quick Response (QR) code on the shipment that, when read by any of the servers 101, 104, or 105, causes specification values for the shipment to be transmitted to the enterprise.

The certificate of analysis 112 may be provided in electronic form to the enterprise when the supplier server 102 establishes a communication session with the specification compliance server 101, and transmits the electronic certificate of analysis 112 to the specification compliance server 101. The electronic certificate of analysis 112 is received by the specification compliance server 101, and is stored on the computer-readable storage medium 109 in association with information that identifies the shipment 114, i.e., in a database or a table. A later query of the database or table using an identifier of the shipment will return the electronic certificate of analysis 112, or attribute values from the certificate of analysis 112.

Alternatively, a physical certificate of analysis 112 may be delivered in physical form from the supplier to the enterprise. The physical certificate of analysis 112 may be delivered with or apart from the shipment 114, and may be scanned in to electronic form by the enterprise and stored on the computer-readable storage medium 109 for subsequent processing. When a physical certificate of analysis is received, a duplicate form detection process implemented by the intra-enterprise specification compliance application 110 checks to ensure that an electronic version of the certificate of analysis has not already been received or stored for the shipment 114 and, if so, deletes the physical certificate or implements a process to confirm whether the values on the physical certificate are the same or different any stored values. The duplicate form detection process may also aggregate or combine values that are supplied on different forms, e.g., by averaging values, ignoring values, filling in missing values on one form with supplied values on another form, selecting the values associated with the most recent date, etc.

Regardless of whether the certificate of analysis 112 is communicated between the supplier and the enterprise in physical or electronic form, the intra-enterprise specification compliance application 110 on the specification compliance server 101 performs, during state (b), an automated or partially automated analysis on the certificate of analysis 112 to identified a certified value or certified values for one or more attributes associated with the ingredient. The process may be, for example, a partially automated process that begins as a fully automated process for identifying values, but that that includes one or manual operations when out-of-range values are detected.

An automated analysis may include, for example, performing an optical character recognition (OCR) process on the certificate of analysis 112. According to some implementations, values or ranges of values for particular attributes are determined when the specification compliance application 110 analyzes a region (or regions) of the certificate of analysis 112 that is defined by the specification compliance application 110 as including or potentially including attribute values, or particular attribute values. The region to scan for a particular value may also be determined dynamically, for instance by recognizing an attribute name and scanning adjacent to the name for a value to be associated with that attribute.

A supplier-specific template may be used to map regions on the certificate of analysis 112 to corresponding attribute values. A supplier may, for example, supply an initial or sample certificate of analysis that shows the absolute or relative position that attributes values will be listed on future certificates of analysis, and the specification compliance application 110 or a user of the application 110 may build a supplier-specific template based on the initial or sample certificate. The template can be created by importing the sample certificate of analysis, defining different zones on the sample certificate of analysis that represent attribute values, optionally defining an order in which each zone is evaluated, and establishing correspondences between zones and attribute names or types. When subsequent certificates of analysis are received from that supplier, the template is selected from among multiple templates that are stored for the various suppliers, and the correspondence or mapping from the selected template is used to appropriately extract attribute values from those certificates.

The supplier-specific templates stored on the specification compliance server 101 may specify that, for a particular supplier, a particular value for a particular attribute is shown in a particular region of a certificate of analysis that is provided by that supplier. The region may be defined in absolute terms, such as by defining a fixed position (e.g., fixed coordinates or dimensions) on a page of a certificate of analysis that should always lists a particular attribute value. The region may also be defined in relative terms, such as by expressing the position of a region of the certificate of analysis that lists a particular attribute, in terms of a position relative of another region of the certificate of analysis or of certain recognized text (e.g., “immediately below the logo” or “three inches to the right of the moisture content attribute value”) or in terms of a position relative to a feature of the page (e.g., “four inches below the header, one inch to the right of the left margin”).

The supplier-specific templates may be updated periodically, to ensure that erroneous attribute values are not input and used for performing intra-application specification compliance. For example, the templates may be reviewed and updated annually, biannually or biennially, or routinely after every N certificates of compliance have been received.

The templates may also be updated on an other-than-periodic basis, such as after determining that certain attribute values that have been automatically read from a certificate of analysis using a template fall outside the usual, normal, possible, or acceptable range of values that are associated with the supplier, attribute, and/or the ingredient. Such a deviation may occur when a supplier's certificate of analysis format has changed without notice, and a value is read in, or an attempt is made to read in a value, that corresponds to the wrong attribute. For instance, if a value of over “100” is read in for an attribute that is expressed as a percentage, or if a value that falls outside of a range of values is read in for an attribute that is restricted to the range (e.g., pH), such values may indicate to the specification compliance application 110 that the mapping or correspondence is out-of-date and requires updating or manual review. In addition to invoking a manual review process, values that have already been read from the certificate of analysis may expunged from storage, disassociated with the shipment, or otherwise deleted or filtered.

In FIG. 1, a supplier-specific template may indicate that a value for the attribute “purity,” is included in the certificate of analysis 112 in a region that is bounded by landmarks 115A-D. That region is scanned or read in using an OCR process to determine that, for the shipment 114, the “purity” attribute of ingredient (in the figure, “red wheat flour”) has a value 116 of “93%.” The automatic analysis may finish when one or more values or ranges of values has been read in, when all values or ranges of values listed on the certificate of analysis 112 have been read in, when all values or ranges of values that have corresponding specification values have been read in, or when one or more values or ranges of values listed on the certificate of analysis are determined to be erroneous or outside of the normal, usual, possible or acceptable ranges.

Fewer than all of the attribute values may be read from the certificate of analysis 112. For instance, if a certificate of analysis includes an attribute, i.e., a “color” attribute or an “inspector name” attribute, that has no corresponding specification value, that value may be ignored, filtered, or otherwise excluded from further processing. Values that are associated with low recognition confidence scores may be similarly excluded, or may invoke a manual review process. Similarly, attribute values that are shown outside of defined OCR zones, or that fall outside upper or lower thresholds, may not be read in or processed.

While the process for generating templates and determining a value or range of values for different attributes listed on the certificate of analysis 112 has been described as an automated or partially automated process, in other implementations these processes may be performed manually, either fully or in part. For instance, a data entry clerk may review certificates of analysis 112 as they are received, and may review and manually enter attribute values into the specification compliance server 101. Manual entry of attribute values may also be initiated after automated processes have failed, or have determined that automatically obtained values may be erroneous or suspect. For instance, the specification compliance application may forward a certificate of analysis to a data entry clerk if an automatically obtained value falls outside of a normal, acceptable, usual or possible range, or when recognized text is associated with a low recognition confidence score.

During state (c), the enterprise accesses a specification that indicates a value or a range of values (referred to collectively as “specification values”) for one or more of the attributes. To obtain a specification value for the “purity” attribute, the document management server 104 selects a current specification associated with the supplier, shipment, and/or ingredient, from among multiple specifications that may be stored on the document management server 104. Specifications may be stored in client-specific tables or databases, as other types of electronic documents or files such as spreadsheets, or electronic versions of paper documents.

In FIG. 1, for example, the document management server 104 selects a contract 117 that is associated with the supplier and the ingredient, and transmits an electronic version of the contract 117 to the specification compliance server 101 over the networks 106. From the contract 117, the specification compliance server 101 determines that the specification value promised by the supplier for the ingredient value “red wheat flour” is “98%.” The electronic version of the contract 117 may be a look-up table that the specification compliance application 110 may query attribute names against in order to determine attribute values. Alternatively, the electronic version of the contract 117 may undergo a similar OCR process as the certificate of analysis 112, to determine attribute values by analyzing regions of the contract 117 in which the attribute value is known (or is expected) to be shown.

During state (d), the enterprise compares the value or range of values from the document, for each attribute, to the specification value or range of values for the attribute, to identify an extent to which the attribute in the particular shipment of the ingredient satisfies or fails to satisfy the specification. In doing so, the specification compliance server 101 determines that the “93%” value for the purity attribute reflected on the certificate of analysis 112 is lower than the “98%” specification value agreed-to or promised by the supplier, by a difference of “5%.”

A standard deviation or other normalized metric can be calculated based on the extent of any deviation, can optionally be aggregated with other data, and can be used to calculate a risk score for the supplier, the ingredient, the shipment, and/or the attribute. For instance, a raw measurement of the deviation (“5%”) can be input to a rule (e.g., rules 111) or a look-up table that is specific to the attribute, shipment, and/or supplier, to output a normalized value that scores the extent to which the shipment deviates, in terms of normalized values that are not easily traceable back to a particular shipment and/or supplier, or to the enterprise. Selection of the appropriate attribute, shipment, and/or supplier-specific rule or look-up table may be a precursor operation to calculating the normalized metric. Alternatively the actual value and the specification value may be input to a standard deviation engine, which calculates a “Z-score” that reflects the extent of the difference.

During state (e), the enterprise automatically determines an action to be taken on the shipment 114, or takes an action on the shipment 114, based on the extent to which the shipment 114 satisfies or does not satisfy the specification. The action to be taken may also be indicated by the shipment, attribute, and/or supplier-specific rule or look-up table that is used to generate a normalized score.

If the shipment does not satisfy the specification (e.g., either by any extent, by an insignificant extent, or by a significant extent), the enterprise may, for example, take action to reject the shipment 114, notify the supplier that the shipment 114 does not satisfy the specification (“is out of spec”), request that the supplier remediate the shipment 114, notify an employee of the enterprise, mark or flag the shipment 114 for further internal processing, blend the ingredient included in the shipment 114 with ‘in spec’ ingredients from other shipments, accept the shipment 114 anyway, or take any number of other appropriate actions. If the shipment does satisfy the specification, the enterprise may accept the shipment 114, may notify an employee of the enterprise, may submit the shipment for further testing, may mark or flag the shipment 114, may expedite payment, may post a favorable review of the supplier, or may take another action.

A deviation may be regarded by an enterprise as significant or insignificant based on the identify of the supplier, or the type of ingredient, shipment, or attribute, based on criteria that are encoded in the rules 111. For instance, the rules 111 may specify multiple actions to be taken based on the extent to which the shipment 114 satisfies or deviates from the specification, where more drastic actions (such as the rejection of a shipment 114) may be taken for significant deviations, and actions that ultimately result in acceptance of the shipment 114 may be associated with insignificant deviations or the absence of a deviation.

In FIG. 1, the “5%” deviation between the specification value and the value listed in the certificate of analysis 112 is input to the rules 111. A rule (reflected in table 119) that is associated with the supplier, the shipment, or the ingredient indicates, for example, that deviations in the “purity” attribute of “1%” or less will result in an “accept” action. The fact that a deviation of “1%” or less ultimately results in the acceptance of the shipment 114 leads to the inference that, in the context of this particular supplier, ingredient, and shipment, such a deviation is considered to be insignificant.

The rules 111 also provide that deviations between “1%” and “4%” will result in a “remediate” action, and deviations of greater than “4%” will result in a “reject” action. Such rules reflect the fact that, in the context of this particular supplier, ingredient, and shipment, the significance of any deviation increases as the magnitude of the deviation increases over “1%”, or that the ability to remediate a shipment exists when the deviation is between “1%” and “4%,” but that it is impossible to remediate a shipment when the deviation exceeds “4%”.

Because the deviation shown in FIG. 1 represents a “5%” deviation, the specification compliance server 101 determines that the corresponding action is a “reject” action, and transmits a message 120 to the shipment management server 105 to reject the shipment 114. This results, during state (f), in the enterprise's employees receiving a notice through the shipping department server 104 from the specification compliance application 110 to place the shipment 114 back on a truck 121, to be sent back to the supplier. The specification compliance application 110 may itself automatically take action to reject the shipment, such by activating a conveyer belt to place the shipment 114 back on the truck, by notifying a delivery service to return or not deliver the shipment 114, or by scheduling a return of the shipment with the enterprise's employees, the delivery service, or the supplier.

The specification compliance server 101 may also transmit a message to the supplier server 102, to indicate that the shipment 114 is being rejected. Other actions may also be automatically initiated, such as a legal process to begin a claim against the supplier, a feedback process to alert other receiver entities of the deviation, an update process to provide normalized values regarding the shipment to a global ingredient database, an evaluation process to evaluate the performance of the supplier, or an accounting process to stop or prevent payment for the shipment.

Using the process illustrated in FIG. 1, an enterprise can automatically analyze a certificate of analysis for a shipment of an ingredient before or after the shipment is received, to identify attributes associated with the ingredient in the shipment. The analysis may result in the identification or determination of values, or of ranges of values, that are associated with different quality or purity attributes of the ingredient in the shipment.

The comparison of these values to the specification values allows the enterprise to determine or quantify the extent to which the shipment satisfies or deviates from the specification and, by extension, the extent to which the supplier has honored or failed to live up to their commitments. Depending on the nature or extent of any deviations between received attribute values and promised specification values, various actions may be taken on the shipment, or on future shipments from the supplier.

Further comparison of the values obtained from the certificate of analysis with attribute values generated by the enterprise may allow the enterprise to determine the extent to which the supplier-provided certificate of analysis is accurate, as a reflection on the credibility of the supplier or the agent of the supplier that is certifying the certificate of analysis. For instance, if a certificate of analysis indicates that an attribute value is “98%” but independent testing by the receiver indicates that the actual attribute value is “93%”, the difference between the certified value and actual value can be quantified, aggregated with other values for the supplier, and associated with the supplier as part of a credibility risk score.

Such an analysis allows the enterprise to aggregate data across multiple suppliers, shipments, ingredients and attributes to generate a so-called “liars report” that indicates the accuracy of the certified statements of various suppliers. Information identifying the extent to which a supplier's certificates of analysis are generally considered to be accurate may be used by the enterprise in supplier selection and evaluation processes, or may be normalized and shared with other enterprises that are considering doing business with the supplier.

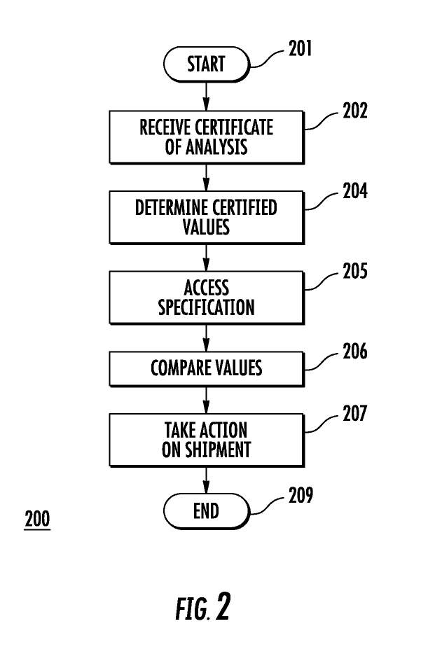

FIG. 2 is a flowchart of an exemplary process 200. Briefly, the process 200 includes receiving a document pertaining to particular shipment of an ingredient from a supplier, automatically determining, from the document, a value or a range of values for each of one or more attributes associated with the ingredient, and accessing a specification that indicates a value or a range of values for each attribute. The process 200 also includes comparing, for each attribute, the value or range of values from the document to the specification value or range of values for the attribute, to identify an extent to which the attribute in the particular shipment of the ingredient satisfies the specification, and automatically taking action on the shipment based on the extent to which the shipment satisfies the specification.

In further detail, when the process 200 begins (201), a certificate of analysis or other document pertaining to particular shipment of an ingredient, is received from a supplier or agent of the supplier, such as an in-house or third-party laboratory (202). The certificate of analysis may be known by other names, such as a “laboratory report,” or a “certificate of compliance.” Information pertaining to the shipment may be obtained other ways as well, such as from shipping documents, through data sharing portals or Application Programming Interfaces (APIs), by first party testing or measurement performed by the enterprise, or through third party testing performed at the request of the supplier or the enterprise.

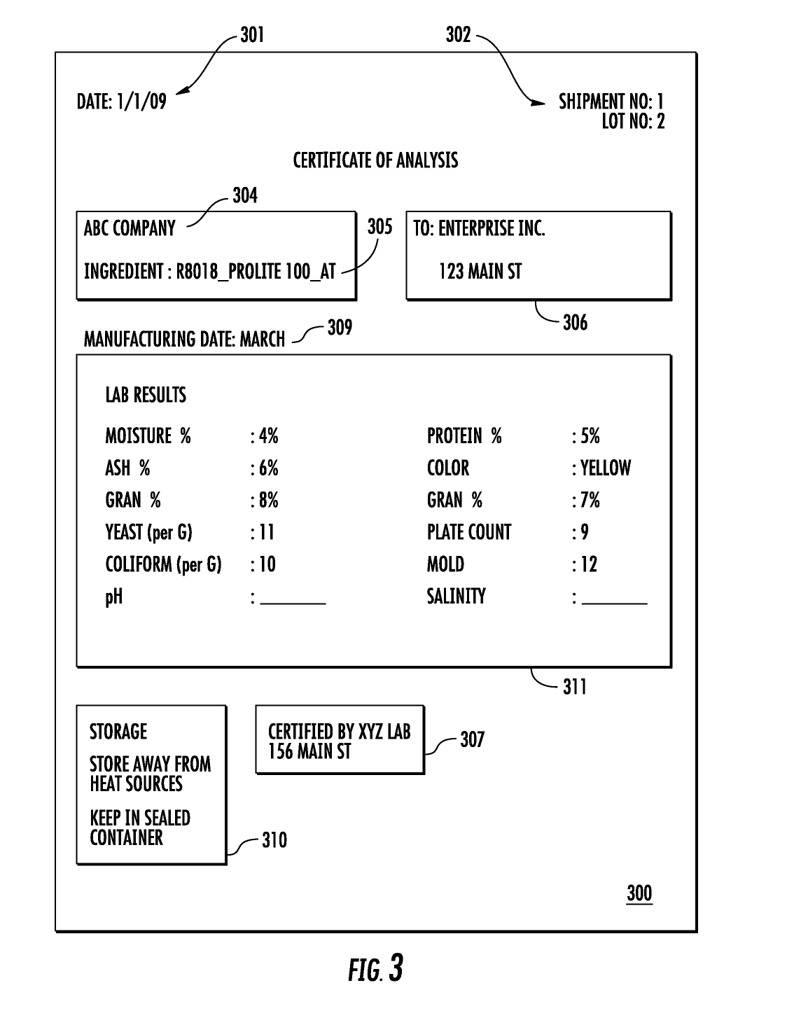

Referring ahead briefly, FIG. 3 depicts an example certificate of analysis 300. Among other information that may be included on this document, the certificate of analysis includes date information 301 that indicates when the certificate of analysis was prepared or provided to the enterprise, and/or when the shipment was sent or received. The shipment itself is uniquely identified by shipment information 302.

The certificate of analysis may include supplier information 304 that identifies the supplier of the ingredient, name information 305 that identifies the name of the ingredient (as commonly used or as assigned by the supplier), enterprise information 306 that identifies the recipient of the shipment, and preparer information 307 that identifies the entity that prepared the certificate of analysis 300 or that determined or validated some or all of the information that is shown on the certificate of analysis 300. The certificate of information 301 may include other information about the shipment or the ingredient, such as manufacturing information 309 or storage information 310.

The certificate of analysis 300 includes an attribute region 311 that shows the various attributes of the shipment of the ingredient 305, and values or ranges of values associated with some or all of the attributes. The attribute region 311 may include multiple attribute name/attribute value pairs. For example, the attribute region 311 shows that the attribute “moisture %” has an attribute value of “4%.”

Because the certificate of analysis may use a predefined format that is common to many different types of ingredients, attribute values may not be supplied for all attributes or blank or null values may be shown. On the certificate of analysis 300, for example, the attribute “pH” has no associated attribute value. In certain implementations, fewer than all of the attribute values shown on the certificate are analysis are used for performing specification compliance. A “color” attribute may be ignored, for example, if no corresponding specification value has been agreed upon by the supplier.

A value or a range of values is automatically determined from the document, for each of one or more attributes associated with the ingredient (204). Automatic determination of attribute values may include digitizing a certificate of analysis, performing an OCR process on the digitized certificate, and obtaining values shown in regions or zones of the certificate that, through analysis of previous or sample certificates of analysis from the supplier, are known by the enterprise to be associated with particular attributes or attribute values. Because different suppliers may use different certificates of analysis for the same ingredient, supplier-specific templates, or supplier-and-ingredient specific templates, may be used to locate values for particular attributes, from among the various types of information shown in a given certificate of analysis.

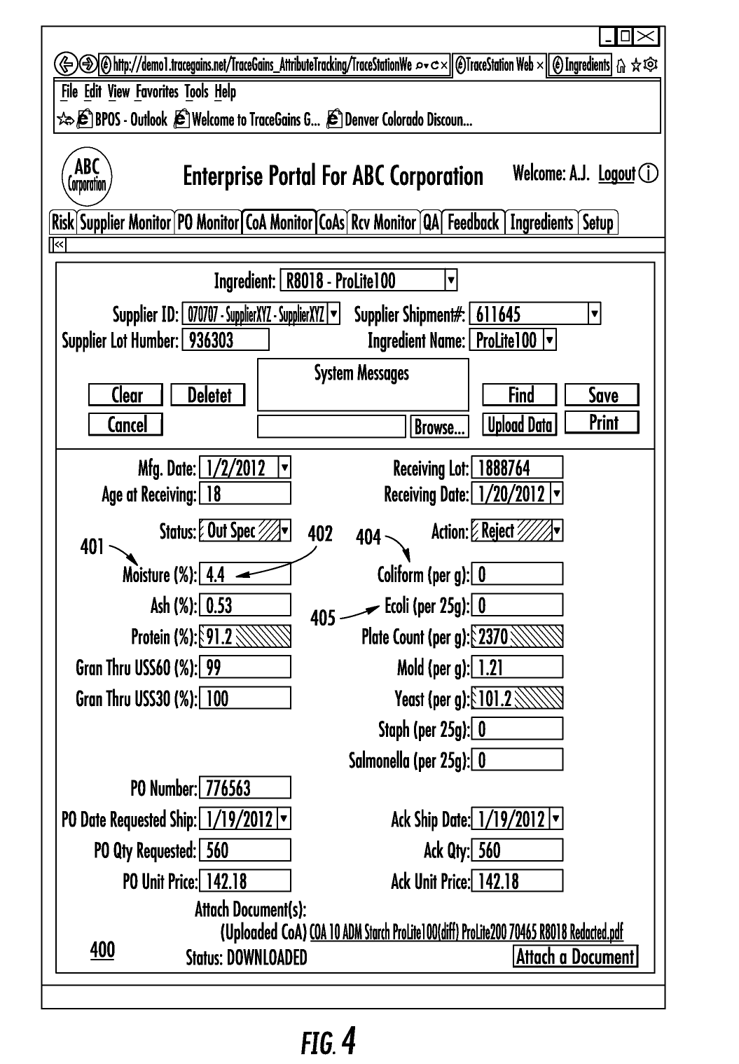

Referring ahead briefly, FIG. 4 is an example screenshot 400 of an intra-enterprise specification compliance application, in a state where some of the attribute values shown on the certificate of analysis 300 have been automatically read in and stored. The screenshot 400 lists several attributes (e.g., “Moisture (%)” attribute 401) and corresponding attribute values (e.g., attribute value “4.4” 402 for “moisture” attribute 401) that have been obtained by automatically analyzing the certificate of analysis 300. The fact that some attribute values are not obtained for several attributes (e.g., “Coliform (per g)” attribute 404 and “Ecoli (per 25 g)” attribute 405) may indicate that these attributes are not included on the certificate of analysis, that no corresponding specification values exist for these attributes, that automatically obtained values fell outside upper and lower control limits, or that these attributes are not defined for the ingredient.

In alternative implementations, automatic determination of attribute values may include accessing a mapping that identifies portions of the certificate of analysis correspond to the various attribute values. When the certificate of analysis is (or includes) a spreadsheet, for example, the mapping may map cell references to corresponding attribute values. When the certificate of analysis is (or includes) a markup language file, such as an XML file, the mapping may map XML tags to corresponding attribute values.

The value or range of values may also be determined without using a certificate of analysis, such as where the enterprise queries a web service operated by the supplier to identify attributes and attribute values associated with a particular shipment. Alternatively, the enterprise may set up a web page that lists attribute names, and that allows the supplier to manually or automatically enter values, among other information, for a shipment of an ingredient. The supplier may be required to submit an e-affidavit after entering the values, to certify that they are accurate. The enterprise itself may also manually enter attribute values, either as a matter of routine or after an unsuccessful attempt has been made to automatically obtain these values.

Before the value or range of values is compared with specification values, the values may be checked to determine whether they fall outside usual, normal, or threshold values that are associated with a particular supplier and/or ingredient. A value of “37” for “pH,” for example, may indicate that an incorrect or non-corresponding value was read for the “pH” attribute. Incorrect values may be read, for example, when a document is incorrectly scanned in, or when additional or fewer attributes than normal are shown on a certificate of analysis, such as when the supplier changes the format of their standard certificate of analysis.

When values are determined to be out of bounds, the document may be processed again, or the document can be flagged for human review. Furthermore, a process for reviewing and updating any templates associated with the supplier may be initiated to confirm that the supplier's certificate of analysis format has not changed or cause the template to be updated. In addition to or instead of analyzing attribute values to determine whether the format of the certificate of analysis has changed, the changes in the position of other information on the certificate of analysis, such as logos, headers, or shipping information, can suggest the occurrence of format changes that renders the review of a supplier's template appropriate.

A specification is accessed, where the specification indicates a value or a range of values for each attribute (205). The specification values may be numeric values, characters or strings of characters, Boolean values (e.g., true/false, yes/no), or other types of values that quantitatively or qualitative describe an attribute of the ingredient that the supplier has committed to providing in the shipment. For a particular attribute, a single specification value may represent a desired value, upper acceptable range value, an upper value that defines the lower range of a warning track, a lower acceptable value, a lower value that defines the upper range of a warning track, or another value. Multiple specification values for a single attribute may define an upper and lower control limits that indicate range of acceptable values.

For each attribute, the value or range of values from the document is compared to the specification value or range of values for the attribute, to identify an extent to which the attribute in the particular shipment of the ingredient satisfies the specification (206). A standard deviation or Z-score may be calculated for the supplier, the ingredient, the shipment or the attribute, based on any deviation, and one or more risk scores may be updated.

The extent to which the attribute satisfies or deviates from the specification may be quantified in many different ways. In some implementations, the value is quantified as a risk score that is particular to that supplier, ingredient, shipment and/or attribute, and that may be aggregated with other risk scores for the supplier, ingredient, shipment and/or attribute to tally a combined risk score.

The risk score may be expressed as a difference value that may be calculated by subtracting one of the certified value and the specification value from the other. The risk score may also (or instead) be expressed as a percentage value that may be calculated by dividing one of the certified value and the specification value by the other. The risk score can be expressed as a standard deviation value, in standard deviation units. The risk score may also be calculated using an algorithm or a look-up table that accepts the raw or actual deviation amount as an input, and that maps the raw or actual deviation amounts to normalized values. To make the normalized values meaningful for use in a comparison, different algorithms may be used to normalize the values to fit within different ranges.

For instance, the risk score can be expressed in a normalized score that is calculated by, for example, inputting a difference value, percentage value, or standard deviation value into an algorithm or look-up table, to determine a normalized score that cannot be traced back to a particular recipient, supplier, ingredient, shipment or attribute. In one example, the risk score is normalized to a range of “1” to “5”, or “0” to “100,” where one end of the range corresponds to full satisfaction of the specification, and the other end of the range corresponds to a failure to satisfy the specification (e.g., deviation from the specification by more than a predefined amount). By normalizing the risk score, meaningful information about suppliers can be anonymized and shared by the enterprise, without revealing sensitive information that might put an enterprise at a disadvantage to a competitor, or without prejudicing the normalized values provided by small or infrequent consumers of a particular ingredient. Depending upon how risk scores are scaled or configured, full satisfaction of the specification can be expressed as a low risk score, or as a high risk score.

Action is automatically taken on the shipment based on the extent to which the shipment satisfies the specification (207), thereby ending the process 200 (209). For example, the risk score or other quantified value can be input to a rule to determine an action that has been associated with the score or value. Other context information can also be used in conjunction with a risk score to determine the action to take on the shipment. Taking action on the shipment may also include updating a global ingredient database with one or more normalized values (e.g., risk scores) that correspond to the shipment.

In the situation where certificates of analysis are provided to an enterprise in advance of the ingredient being shipped, a receiving department at the enterprise may be given a list of expected shipments that identifies those shipments that should be accepted and rejected. By indicating a corresponding action for each expected shipment, this report is helpful in the situation where a supplier sends an ‘out of spec’ ingredient despite being informed that the ingredient is ‘out of spec’ and should not be shipped.

The attribute may fully satisfy the specification when the value shown in a certificate of analysis matches or is within an acceptable range of a specification value. Full satisfaction of the specification may result in the shipment being accepted by the enterprise. Ingredients of a shipment that fully satisfy specification values may be held or put aside by the enterprise, to be blended with other shipments of the ingredient that may not fully satisfy specification values.

The attribute may satisfy the specification, yet the value shown in the certificate of analysis may be close to being ‘out of spec,’ by either being close to being too high or too low. These shipments, which are referred to as “warning track” satisfactory shipments, may be accepted. Additional actions may be taken on “warning track” satisfactory shipments to render the attribute closer to the specification value, such as by blending the ingredient with other shipments of ingredients or asking or warning the supplier to ship ingredients that are in better compliance with the specification.

The attribute may not satisfy the specification, yet the value shown in the certificate of analysis may be close to being ‘in spec.’ When a certificate of analysis indicates that one or more attributes are close to being ‘in spec,’ the shipment may be automatically accepted or rejected, a message may be generated to ask an employee of the enterprise such as a plant manager to make a decision as to accept or reject the shipment, the shipment may be put in an ‘on hold’ area of the enterprise, or a process may be automatically initiated to find a new supplier or warn the existing supplier.

The attribute may not satisfy the specification, and may not be close to being ‘in spec.’ Significant deviation from the specification value for one or more of the attributes of the ingredients may result in the shipment being automatically rejected, payment being withheld, a claim for damages being initiated, the shipment being sent for additional testing or evaluation, and/or the supplier being notified.

In some implementations, the set of business rules defines seven ranges, reflecting the spectrum of conditions that may occur in a particular shipment. These ranges may include an ‘out of spec, high—reject’ range of values, an ‘out of spec, high—ask’ range of values, an ‘inspect, warning track, high—accept’ range of values, an ‘accept’ value or range of values, an ‘inspect, warning track, low—accept’ range of values, an ‘out of spec, low—ask’ range of values, and an ‘out of spec, low—reject’ range of values.

Other information may also be used to determine whether or not to ultimately accept or reject a shipment. For example, the enterprise may store data describing qualitative or quantitative characteristics of the ingredient as observed on the loading dock, the results of independent laboratory evaluations or of in-house or third party quality assurance analysis. Furthermore, the enterprise may store downstream performance feedback regarding the performance of similar ingredients from the same supplier, or of similar ingredients with similar attribute values from the same supplier, as observed by downstream manufacturing or retail store operations, or by consumers.

When one or more attribute values of a particular shipment of an ingredient indicate the shipment is nearly ‘out of spec’ or nearly ‘in spec,’ this data can be used to determine whether or not to accept a shipment. For instance, if a shipment of an ingredient is nearly ‘in spec,’ data that indicates that a past shipment of an ingredient from the same supplier that was ‘out of spec,’ or nearly ‘in spec,’ exhibited wide retail store or consumer acceptance, the enterprise may choose to accept the shipment. Conversely, if a shipment of an ingredient is nearly ‘out of spec,’ data that indicates that a past shipment of an ingredient from the same supplier that was ‘in spec,’ or nearly ‘out of spec’ resulted in poor end-user feedback, the enterprise may choose to reject the shipment.

Deviation trend information for a particular supplier may also be used by an enterprise to determine whether to accept or reject a particular shipment. For instance, a first occurrence of a nearly ‘out of spec’ or a nearly ‘in spec’ shipment may be accepted after transmitting a warning to the supplier to perform enhanced quality review. A second or subsequent occurrence of a shipment that is not fully in compliance, or an increasing rate of non-compliant shipments from the same supplier, may trigger a non-complying shipment to be rejected without further warning.

The enterprise may use a risk score for a particular supplier, ingredient, shipment or attribute to generate or alter one or more aggregated, normative metrics for the shipment, the supplier, the ingredient, or the attribute. The metric may quantify the deviation of the certificate of analysis attribute value from the desired specification value (or mean specification value) for the attribute, specified in standard deviation units. Where the enterprise performs additional quantitative or qualitative analysis of the shipment, the risk score may also quantify the deviation from the actual attribute value, measured by the enterprise, from the certificate of analysis value reported by the supplier.

In quantifying the deviation of all ingredients and attributes supplier or reported by the supplier, the score may reflect the credibility and reliability of the supplier, indicating, for instance, how far off the supplier's shipment was from the specification values, or how far off the supplier's certificate of analysis was from the attribute values as measured by the enterprise. A second derivative of the risk score may reflect which suppliers are trending in positive or negative directions. The enterprise may use a supplier's risk score in their supplier selection and evaluation processes, allowing the enterprise to make the decision to choose a particular supplier based on more than price and the supplier's promised, future performance.

When a normative metric is calculated for a particular ingredient, the metric may quantify the average deviation of all attributes for the ingredient. Using this metric, the enterprise may determine, for instance, whether shipments of an ingredient are usually ‘in spec’ or ‘out of spec,’ regardless of supplier. According to some implementations, an overall risk score for a supplier and an overall risk score for an ingredient are updated whenever a shipment is received, based on the information from the latest shipment.

The updated risk scores may be used to generate color coded reports using the risk scores associated with each supplier, ingredient, shipment, or attribute, allowing the enterprise to better evaluate supplier compliance and supplier impact, and increasing visibility and accountability. For example, the color coded report may allow a manager at the enterprise to quickly identify suppliers that most frequently deviate from mean or desired specification values, or from the values exhibited by competitors to the supplier, or from an industry at large. In doing so, the extent to which individual suppliers are meeting a desired target specification may be measured through risk scores that average all deviations by the supplier. By comparing suppliers based on risk score instead of or in addition to price, an “apples-to-apples” qualitative comparison can be made by the evaluator before ordering an ingredient.

Instead of or in addition to analyzing the attributes of ingredients, a similar process to exemplary process 200 may also be used to analyze the attributes of suppliers to determine the extent to which suppliers have satisfied or deviated from a specification. For instance, documents (e.g., audit results) pertaining to the supplier of an ingredient may be received. From the document, a value or a range of values for each of one or more attributes associated with the supplier may be automatically determined (e.g., a date of a last audit). A specification that indicates a value or a range of values for each attribute (e.g., an audit frequency) is accessed and, for each attribute, the value or range of values from the document is compared to the specification value or range of values for the attribute. Based on this comparison an extent to which the attribute of the supplier satisfies the specification is determined. This extent may be used in the normal course of choosing and evaluating suppliers.

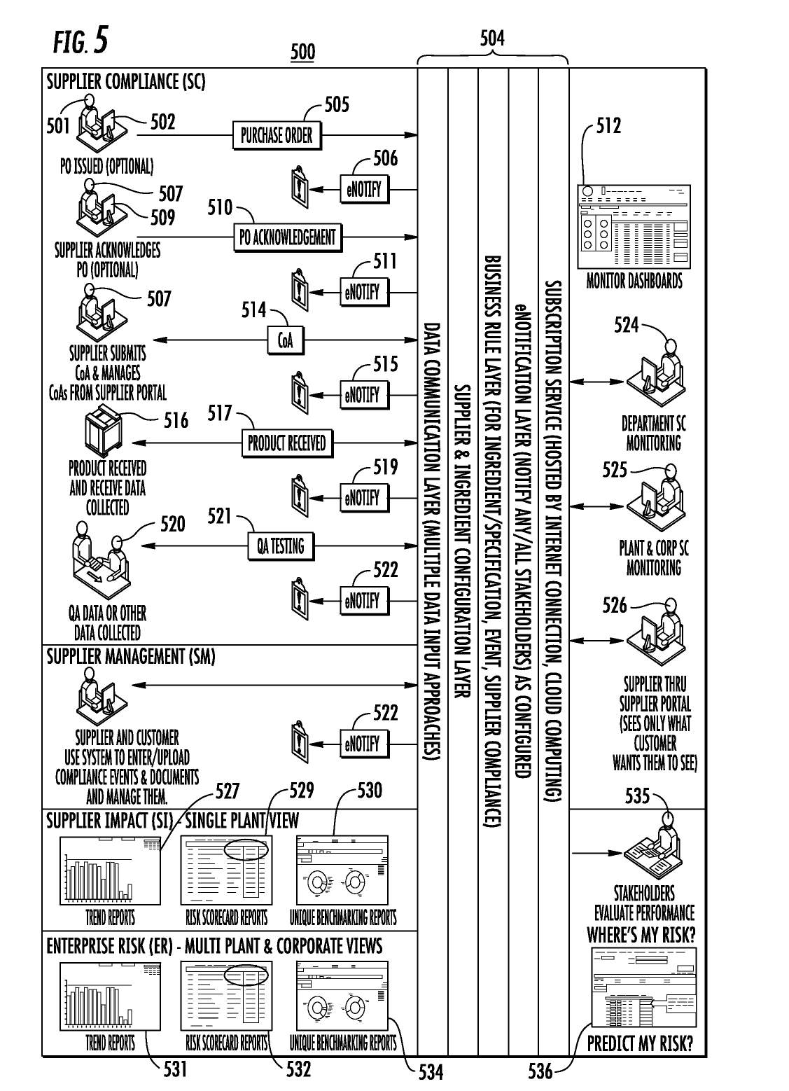

FIG. 5 is a diagram of an example system 500. An agent 501 of an enterprise uses a computer 502 to interface with a service 504, e.g., through a SaaS subscription, to optionally enter a purchase order 505 for an ingredient. The service 504 provides a notification 506 to an agent 507 of a supplier that is interfacing with the service 504 through a computer 509. The notification 506 to the agent 507 optionally triggers an automatically or manually-initiated acknowledgement 510 of the purchase order 505, which triggers the service 504 to provide a notification 511 of the acknowledgement to the enterprise.

Before or concurrent with shipping the ingredient, the agent 507 of the supplier transmits a certificate of authenticity (in the figure, “CoA”) 514 to the service 504, triggering the service 504 to transmit a notification 515 to the supplier and/or the enterprise. When a shipment 516 of the ingredient is physically received by the enterprise, the agent 501 of the enterprise provides a notification 517 to the service 504, triggering the service 504 to provide a notification 519 of the receipt of the shipment 516 to the supplier.

The agent 501 may submit the shipment for quality assurance testing by a quality assurance agent 520 of the enterprise. Quality assurance data 521 collected from the quality assurance testing is provided to the service 504, triggering the service to transmit a notification 522 to the supplier.

Using the information sent to and received by the enterprise and supplier, the service 504 may provide dashboard interfaces 512 that provide the current status of a purchase order and/or shipment to an agent 524 that is monitoring the supply chain on behalf of a supply chain monitoring department of the enterprise, to an agent 525 that is monitoring the supply chain on behalf of a plant or corporate supply chain monitor for the enterprise, or to an agent 526 of the supplier. The dashboard 512 that is provided to the agent 526 may display limited information about the shipment, depending upon parameters that are defined by the enterprise.

The dashboards 512 may convey different types of information to the supplier and the enterprise. The dashboards 512 may be populated with data that the enterprise generates, and/or data that is received from other enterprises received, for instance, from a global ingredient database. The information may include, for instance, trend reports 527 that show the trend of risk scores for a supplier, attribute, or ingredient, over a user-selectable period of time, as observed by a particular plant within an enterprise. Risk scores may also be used to develop risk scorecard reports 529 that rank different suppliers based on past shipments, and benchmarking reports 530 that compare the performance of suppliers to industry standards.

Risk scores from multiple plants associated with an enterprise can be aggregated to develop aggregated trend reports 531, aggregated risk scorecard reports 532, and aggregated benchmarking reports 534 that are not specific to a particular plant. Using this information, stakeholders can generate reports 536 that highlight and predict risk, based on the actual, observed performance of suppliers.

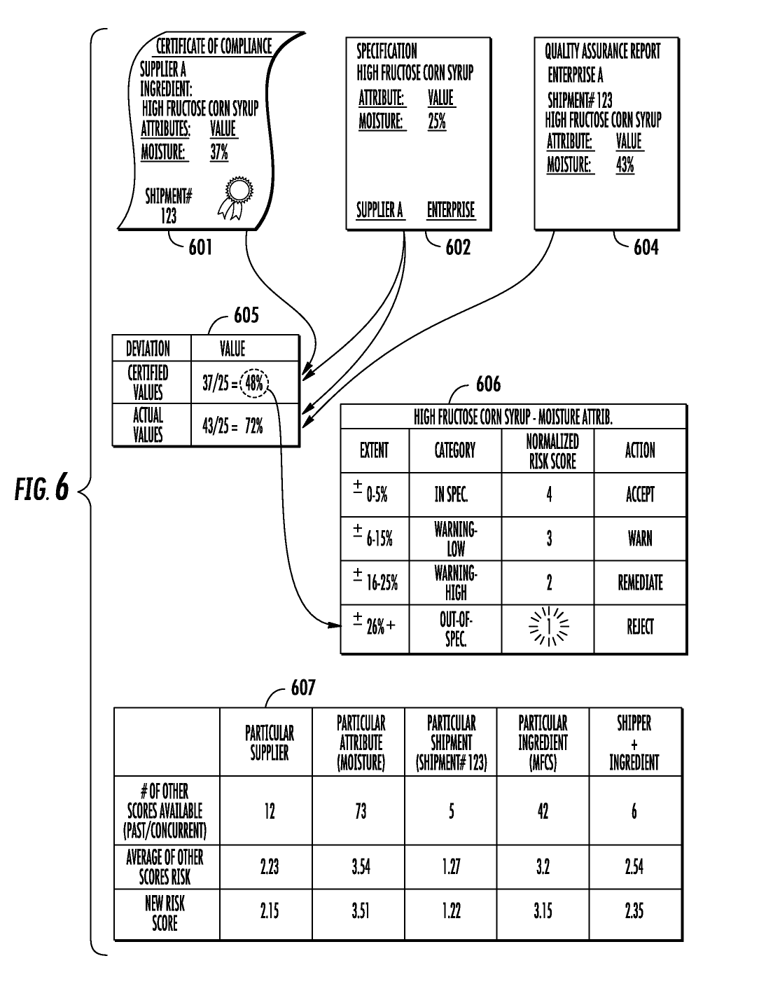

FIG. 6 shows an example of the calculation of risk scores for a sample shipment of an ingredient. A shipment of an ingredient may be associated with three or more different documents: a certificate of compliance 601 that is received from the supplier or an agent of the supplier (in the figure, “supplier A”), a specification 602 that details the promised characteristics of the ingredient or shipment, and quality assurance testing results 604 that the enterprise may generate after receiving the shipment. In this example, the certificate of compliance 601 indicates that, in this shipment (in the figure, “shipment #123”), the ingredient (in the figure, “high fructose corn syrup”) has a “moisture” attribute value of “37%.” The specification indicates that the “moisture” attribute is supposed to have a value of “25%,” while the quality assurance report indicates that the ingredient actually has a “moisture” attribute value of “43%.”

As shown in table 605, the specification value (“25%”) is compared with both the certification value (“37%”) and the actual value (“43%”) to determine the extent to which the ingredient deviates from the specification. In this example, the certified value deviates from the specification value by “48%,” and the actual value deviates from the specification value by “72%.”

A look-up table 606 is selected for the ingredient and attribute combination. The deviation between the certified value and the actual value is input to the look-up table 606 to classify the deviation, to generate a normalized risk score, and to determine an action to take upon the shipment. In FIG. 6, the table 606 indicates that a deviation of “48%” represents an “out-of-spec” condition, which is assigned a normalized risk score of “1.” The table 606 further indicates that the shipment should be rejected for being out-of-spec.

The normalized score of “1” for the moisture attribute in this particular shipment is used to update the risk scores associated with the supplier, the attribute, the shipment, the ingredient, and any appropriate combination thereof. For instance, the table 607 indicates that the particular shipment (“shipment #123”) had “5” other attributes that exhibited an average risk score of “1.27.” Factoring in the normalized risk score of “1” for the moisture attribute, the risk score for the particular shipment drops to “1.22.”

The risk score for the particular shipment may be used to update the risk score for the supplier, e.g., locally at the enterprise and/or at a global ingredient database. For instance, the table 607 indicates that the particular supplier (“supplier A”) previously delivered “12” other shipments, with an average risk score of “2.23.” Factoring in the risk score of “1.22” for this shipment, the risk score for the supplier drops to “2.15.” In a similar manner, the risk score for the “moisture” attribute falls to “3.51,” and the risk score for the ingredient “high fructose corn syrup” falls to 3.15.

Risks scores can be calculated for various shipment, attribute, ingredient, and supplier combinations. For instance, table 606 indicates that the particular supplier (“supplier A”) shipped “6” previous shipments of this particular ingredient (“high fructose corn syrup”), with an average risk score of 2.54. Factoring in the risk score of “1.22” for this shipment, the risk score for the combined supplier and ingredient combination falls to “2.35.”

In summary, and using the intra-enterprise ingredient specification compliance techniques described above with reference to FIGS. 1 to 6, an enterprise can automatically analyze a certificate of analysis for a shipment of an ingredient before or after the shipment is received, to identify different quality or purity attributes associated with the ingredient in the shipment, and values associated with the identified attributes. The certified values may be compared to a specification that specifies attribute values that the enterprise requires to process the ingredient into a finished product. In some cases, the specification specifies attribute values that a supplier of the ingredient has contracted, promised or otherwise committed to provide in the shipment to the enterprise. This comparison may allow the enterprise to determine the extent to which the shipment satisfies or deviates from the specification and, by extension, the extent to which the supplier has honored or failed to live up to their commitments.

FIGS. 7 to 10 illustrate example systems and processes for performing inter-enterprise ingredient specification compliance, describing, in particular, a global ingredient database that collects normalized data from multiple customers of a supplier to create a global risk profile for suppliers across ingredients and attributes of ingredients.

In doing so, another customer can objectively measure the strengths and weaknesses of a particular supplier based on past interactions between the particular supplier and other customers, without relying on subjective information, and without revealing to the customer information that may be proprietary or sensitive to the other customers. Such an approach may be particularly useful for naïve customers that have little or no exposure to a particular ingredient, supplier, or attribute.

The inter-enterprise ingredient specification compliance techniques described in FIGS. 7 to 10 may have other uses as well. For instance, a customer can objectively evaluate his current suppliers and their performance against a group of their peer suppliers, and against group metrics such as averages or means. In this way, the customer can gain new insights into performance of his existing suppliers and consider strategic sourcing options. Additionally, a supplier can view objective measures of its performance against a group of his peer competitors, gaining insights into how its performance and risk metrics compare. Furthermore, customers, suppliers or independent third parties such as industry consultants or others can review and study supplier performance metrics and risk rankings over time, enabling new trend and projection capabilities.

In more detail, FIG. 7 illustrates an example system 700 for performing inter-enterprise ingredient specification compliance. The system 700 includes receiving entities 701, which include enterprises such as manufacturers that process ingredients into finished products, a global ingredient database 702, and a user 704. The user 704 may be a person or machine affiliated with one or more of the receiving entities 701 or with an entity that have not yet interacted with the global ingredient database 702, such as a naïve receiving entity.

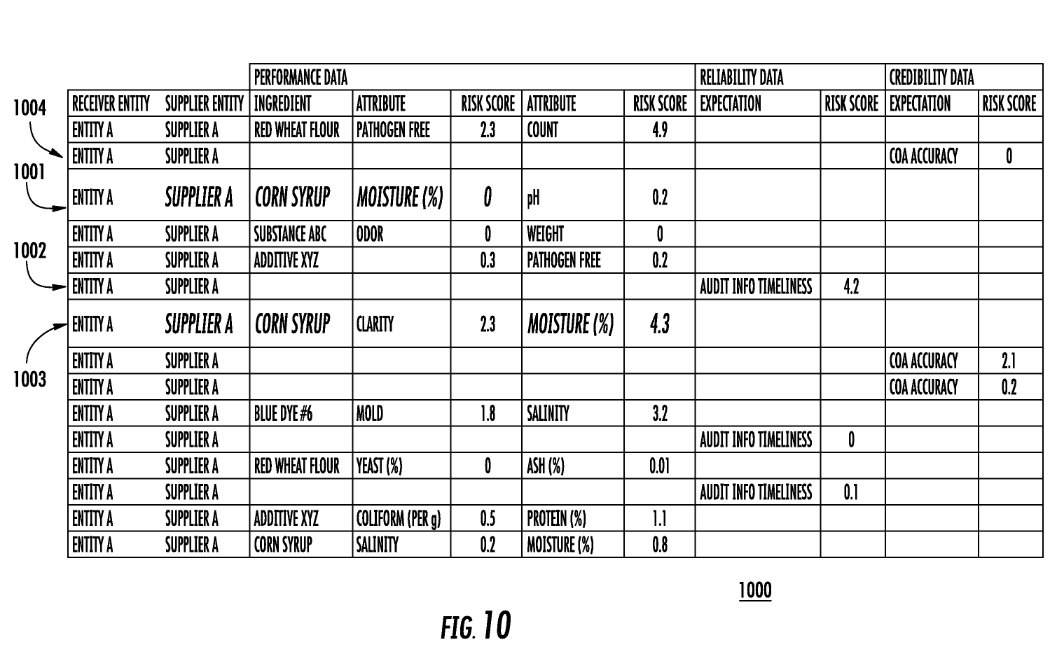

The global ingredient database 702, which stores data that references different ingredients, supplier entities, shipments, attributes and corresponding normalized values, may be implemented on one or more servers, e.g., as a SQL database, that are under the control of one or more of the receiving entities 701, the user 704 or a third party. Alternatively, the global ingredient database 702 may be accessible to the receiving entities 701 or the users 704 under a SaaS subscription. The global ingredient database 702 may be structured as shown in the example table of FIG. 10.

Over time, the receiving entities 701 communicate normalized values that reflect an extent to which supplier entities have satisfied various performance, credibility, or reliability expectations. The data may additionally or alternatively reflect actual and expected values to allow the global ingredient database 702 to calculate normalized values. As shown in FIG. 7, the data may be included in a formatted message (e.g., an XML file) that includes information 706 that identifies a particular supplier entity, information 707 that identifies a particular expectation of the respective receiving entity, and information 708 that identifies a risk score associated with the particular expectation. If necessary, the normalized values themselves are calculated from the actual values and expected values received from the receiving entities 702, and the global ingredient database 702 is populated with the normalized values.

In several examples, a user of the global ingredient database 702 may be a customer that is seeking to evaluate their current suppliers against each other or that is seeking to evaluate a current supplier against suppliers with which they have no existing business relationship, or a supplier that is seeking to evaluate their own performance against other suppliers. When the user 704 selects a particular ingredient, supplier entity, or attribute, information 709 identifying the selection is communicated to the global ingredient database 702, and the global ingredient database 702 aggregates some or all of the normalized values that are associated with the identified ingredient, supplier entity, or attribute. The global ingredient database 702 may optionally analyze the normalized values, providing meaning or context to the normalized values. A representation of the normalized values and/or the analysis is communicated to the user 704.

The representation of the normalized values that is output to the user may include the raw normalized values themselves, an analysis of the normalized values, or some other indicator of the meaning of the normalized values. The indicator may be, for example, a color coded indicator with, e.g., a green icon for a normalized value that is better than average, and red icon for a normalized value that is worse than average. The indicator may also be a ranking of the supplier from among all suppliers that supply a particular ingredient, ranked according to an aggregated normalized value associated with each supplier.

In FIG. 7, a report 710 sent from the global ingredient database 702 to the user 704 includes information 711 that identifies the user's selection, and a first representation 712 of the normalized values, i.e., a raw risk score, and a second representation 714 of the normalized values, i.e., an analysis of the risk score. In an alternative implementation, the representation is included in a machine-readable instruction that instructs a device to automatically take an action with respect to a selected supplier, ingredient, and/or attribute, such as to order or not order an ingredient from a supplier, or to adjust expected attribute values associated with a future shipment of an ingredient from a supplier.

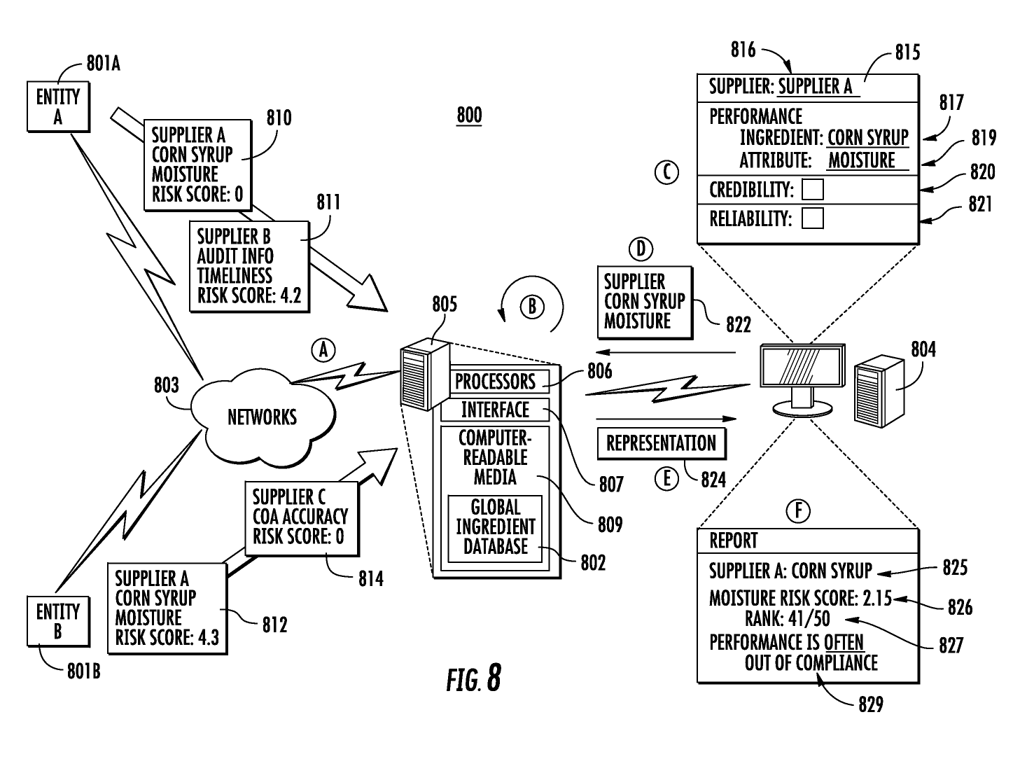

FIG. 8 illustrates another example system 800 which, like system 700, includes receiver entities 801a-b, which are manufacturers that process ingredients into finished products and a user device 804. The receiver entities 801a-b and the user device 804 are in communication with a global ingredient database 802 over one or more networks 803. The global ingredient database 802, which stores data that references different ingredients, supplier entities, and attributes, may be implemented on one or more servers, e.g., a server 805 that includes one or more processors 806, interfaces 807, and computer-readable media 809, and may be accessible under a SaaS subscription. FIG. 8 also illustrates a flow of data between the various components of the system 800, shown in states (A) to (F). States (A) to (F) may be time sequenced states, or they may occur in a different sequence than is illustrated.

During state (A), the receiving entities 801a-b communicate data that reflects an extent to which a supplier entity has satisfied a performance, credibility or reliability expectation. The data may include normalized values, such as risk scores, or data that may allow the global ingredient database 802 to calculate normalized values, such as actual values (or “raw values”) and expected values. The global ingredient database 802 is populated with the obtained normalized values during state (B).

In the illustrated example, the data communicated between the entity 801a and the global ingredient database 802 includes performance data 810, which identifies a particular supplier (in the figure, “Supplier A”), an ingredient (“corn syrup”), an attribute (“moisture”) and a risk score (“0”). In this example, a risk score of “0” indicates that there was no deviation between actual and expected performance, such as where a specification value for the “moisture” attribute of a particular shipment of “corn syrup” was fully met by the ingredients in the actual shipment.

The risk score (“0”) is an objective measurement of the deviation between actual performance and expected performance. The risk score provides anonymity to the receiver entity (“Entity A”), however, by not specifying the actual, relative or absolute amount of moisture content in the ingredient that was received, or the specification value for the moisture content. In this case, however, a viewer of this risk score may be impressed with the supplier entity, since the risk score of “0” indicates that the supplier entity has acted as promised in the shipment of an ingredient to the receiver entity. As shown in record 1001 of FIG. 10, on receipt of the performance data, the global ingredient database 802 stores the value “0” in association with the supplier “Supplier A,” the ingredient “corn syrup,” and the attribute “moisture.”

The data communicated between the entity 801a and the global ingredient database 802 also includes reliability data 811, which identifies a different supplier (in the figure, “Supplier A”), an expectation (“audit info timeliness”), and a risk score (“4.2”). In this example, a risk score of “4.2” suggests that there was a significant deviation between actual and expected performance, such as where audit information was expected on a certain date, but the audit information was actually received on a much later date.

Notably, the risk score of “4.2” provides an objective measurement of the deviation between actual timeliness or reliability, and promised timeliness or reliability. Because the actual deadline and promised deadline are not reflected in the risk score, however, the identity of the receiver entity (“Entity A”) is protected. From this data, however, a viewer may learn that the supplier entity (“Supplier B”) has not lived up to its timeliness expectations in its interactions with customers. As shown in record 1002 of FIG. 10, on receipt of the reliability data 811, the global ingredient database 802 stores the value “4.2” in association with the supplier “Supplier B,” and the expectation (“audit information timeliness”).

The data communicated between the entity 801b and the global ingredient database 802 includes performance data 812, which identifies one of the same suppliers as was identified by the entity 801a (“Supplier A”), an ingredient (“corn syrup”), an attribute (“moisture”), and a risk score (“4.3”). Such a risk score may indicate that there was a significant deviation between actual and expected performance, such as where a specification value for the “moisture” attribute of a particular shipment of “corn syrup” was not met, i.e., deviated by a significant degree, by the ingredients in the actual shipment.

The risk score of “4.2” is an objective reflection of the operational characteristics of the supplier entity (“Supplier A”), specifically identifying the deviation between actual and promised performance in the supplier's past interactions with its customers. A viewer of this risk score may learn that the supplier entity has shipped ingredients that did not live up to expectations. As shown in record 1003 of FIG. 10, on receipt of the performance data, the global ingredient database 802 stores the value “4.3” in association with the supplier “Supplier A,” the ingredient “corn syrup,” and the attribute “moisture.”

The data communicated between the entity 801b and the global ingredient database 802 also includes credibility data 814, specifically data that indicates the extent to which a certificate of analysis provided by a supplier included accurate data. Specifically, the credibility data 814 identifies a supplier (“Supplier C”), an expectation (“COA accuracy”), and a risk score (“0”). A risk score of “0” indicates that the information provided on the certificate of analysis was completely accurate, for example after comparing the provided COA values with values obtained by a third-party lab.

The risk score of “0” is an objective measurement of the credibility of the supplier entity (“Supplier C”). Such a score suggests that, as compared with values provided by a third party, the certificate of analysis provided by the supplier entity was quite accurate. As shown in record 1004 of FIG. 10, on receipt of the credibility data 814, the global ingredient database 802 stores the value “0” in association with the supplier “Supplier C,” and the expectation.

Referring ahead briefly, FIG. 10 provides an example snapshot of the contents of a global ingredient database 1000, shown in a state where (among other data) the data 810, 811, 812 and 814 is stored. Specifically, the performance data 810 is stored in record 1001 of the global ingredient database 1000, the reliability data 911 is stored in record 1002, the performance data 812 is stored in record 1003, and the credibility data 814 is stored in record 1004. Although the global ingredient database 1000 is shown as storing two attributes in the performance data section, fewer or more performance, reliability, or credibility attributes may be stored, and a different data model could also be employed for storing this data.

Over time, different entities communicate this data, reflecting the extent to which various suppliers has satisfied an performance, credibility, or reliability expectations. The global ingredient database 1000 data may store normalized values, and/or actual and expected values that allow the global ingredient database 1000 to calculate normalized values.

Returning to FIG. 8, during state (C), a user of the user device 804 enters information through a user interface 815, where the information identifies a particular ingredient, supplier entity, and/or attribute, and/or information associated with a credibility or reliability expectation, such as information indicating that the user wishes to determine the extent to which a particular supplier satisfies or does not satisfy credibility or reliability expectations. For instance, the user interface 815 may include a field 816 through which a user may enter information identifying a particular supplier, one or more fields 817 through which a user may enter information identifying an ingredient, and one or more fields 819 through which a user may enter information identifying an attribute of the identified ingredient. The user interface 815 may also include a control 820 that allows the user to specify whether credibility testing is desired, and a control 821 that allows the user to specify whether reliability testing is desired.

In the illustrated example, the user has entered information through the user interface 815 to indicate that they wish to learn the extent to which shipments of the ingredient “Corn Syrup” from “Supplier A” satisfy or do not satisfy specification values for the “Moisture” attribute. By leaving controls 820 and 821 unselected, the user indicates that they do not wish to learn the extent to which the supplier (“Supplier A”) satisfies or does not satisfy credibility or reliability expectations.

The user may be a customer that is seeking to evaluate the supplier, with which they have an existing business relationship, against other suppliers with which the user also has a business relationship. Additionally, the user may be a customer that is seeking to evaluate a supplier with which they have an existing business relationship against other suppliers with which they have no existing business relationship. Moreover, the user may be a supplier that is seeking to evaluate its own performance against other suppliers.

Based on the information entered by the user through the user interface 815, the user device 804 communicates, during state (D), a message 822 to the global ingredient database 802 over the networks 803. The message 822 identifies the supplier “Supplier A,” the ingredient “Corn Syrup,” and the attribute “Moisture.”

During state (E), the global ingredient database 802 locates records that match the identified supplier, ingredient and attribute, specifically records 1001 and 1003 of FIG. 10, aggregates the appropriate normalized values, and provides a representation 824 of the normalized values to the user device 804. The global ingredient 802 may locate all records that match the identified supplier, ingredient and attribute, or some subset thereof. For example, only those records that are were populated with data from entities that are similar (e.g., in size, location, order size, etc.) to the entity that is seeking information may be identified and included as part of a subset.

In the illustrated example, the global ingredient database 802 aggregates the normalized values associated with the supplier “Supplier A,” the ingredient “Corn Syrup,” and the attribute “Moisture,” by averaging or otherwise aggregating or combining the respective risk scores. Although other approaches such as summing or weighted averaging may also be used. All matching normalized values may be aggregated, or only those normalized values associated with the selected subset of the records may be aggregated. In the illustrated example, the averaged risk score (“2.15”) is included in the representation 824 that is communicated to the user device 804, as is an automatically generated analysis of that aggregated risk score. In FIG. 8, the automatically generated analysis includes, among other things, the text 829 (“Performance is often out of compliance”).

During state (F), the representation of the normalized values is output to the user as a report 825. The report identifies the supplier “Supplier A,” the ingredient “Corn Syrup,” the attribute “Moisture,” the aggregated risk score 826, a rank 827 of the supplier for that ingredient and attribute combination amongst all suppliers associated with that ingredient and attribute combination in the global ingredient database 802, and the text 829 of the automatically generated analysis. The representation may identify the competitor suppliers to the supplier, e.g., when the user selects a link corresponding to the rank 827, or the competitor suppliers may be cloaked in anonymity.

In FIG. 8, the relatively low risk score and ranking indicates that the supplier “Supplier A” is performing somewhat poorly. If the user currently receives ingredients from the supplier, they may choose to divert more business to other better ranked suppliers, or to demand increase quality or better business terms. If the user is a different supplier, the user may use this information to solicit more business from customers of the supplier, or to negotiate more favorable business terms given the higher quality of its performance. If the user is the supplier, the low risk score may trigger processes to improve its performance, such as by lowering promised standards or increasing quality.

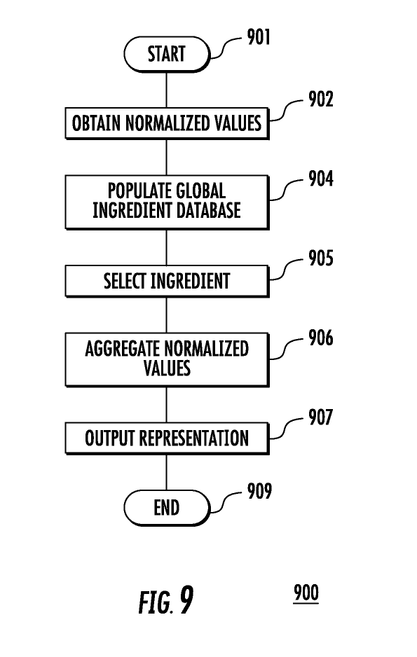

FIG. 9 is a flowchart of a process 900 that is used for inter-enterprise ingredient specification compliance. Briefly, the process 900 includes obtaining one or more normalized values that reflect an extent to which a supplier entity has satisfied an expectation of a receiver entity, and populating a global ingredient database that references different ingredients, and different supplier entities and attributes associated with each ingredient, with the normalized values. The process 900 also includes receiving a user's selection of an ingredient, a supplier entity, or an attribute, aggregating one or more of the normalized values that are associated with the selected ingredient, supplier entity, or attribute in the global ingredient database, and outputting a representation of the aggregated values to the user.

In more detail, when the process 900 begins (901), normalized values are obtained (902). The normalized values may be received from a receiver entity, or the receiver entity may provide one or more actual values and one or more expected values, and the one or more normalized values may be generated using the received values. The receiver entity may be a node in a supply chain that has received an ingredient, such as a restaurant chain, a grocery chain, an ingredient manufacturer, a finished goods manufacturer, an ingredient processor, or a company that purchases ingredients whose attributes have variability.

The normalized values reflect an extent to which a supplier entity has satisfied an expectation of a receiver entity. For instance, the normalized values may reflect an extent to which the supplier entity has deviated from a specification value (e.g., for an attribute of the ingredient), an extent to which the supplier entity's reported values match third party assessed values, or an extent to which the supplier entity has satisfied on-time information requests from the receiver entity. The normalized values may hide actual values associated with a particular shipment.

The normalized value may include a combined risk score for all or some ingredients and attributes provided by a particular supplier, or the normalized value may be a risk score for a particular ingredient or attribute provided by the particular supplier. The risk score may be a second derivative risk score, reflecting whether the particular supplier is trending in a good or bad direction. The risk score may reflect, for instance, a deviation of a COA attribute value from a desired mean specification value for an attribute, and may be specified in standard deviation units.

The normalized value may also reflect the credibility or reliability of a particular supplier, indicating how far off the supplier's reported values were from actual values, such as how far off a particular shipments actual values were from the shipment's specification values. For a particular supplier, the normalized value may be a risk score that is the average of all deviations from all shipments from the supplier.

Using the normalized values, a potential customer of the supplier may balance other factors, such as the supplier's costs and promises, against operational characteristics that reflect the extent to which the supplier's past deliveries are typically “in spec” or “out of spec.” The values are normalized and aggregated to create a single metric for any combination of parameters. The normalized values allow a potential customer to review the operational characteristics of a supplier without necessarily being able to trace these characteristics to a particular shipment or receiving entity. The values may be normalized at any single level, e.g., the shipment, supplier, ingredient, or attribute level, or at any combination thereof.

A global ingredient database that references different ingredients, and different supplier entities and attributes associated with each ingredient, is populated with the normalized values (904). If normalized values are already stored in the global ingredient database for a particular ingredient, supplier entity, or attribute, the obtained normalized values may be used to update the stored attributes, e.g., through an aggregation operation.

Before storing the normalized values, the information received from the receiver entity may be taxonomized, to standardize attribute, ingredient, and supplier identifiers. Once taxonomized, potential customers may view and use the normalized values for a particular ingredient, supplier or attribute, even if different receiving entities use different names for the ingredient, supplier or attribute.

In addition to being populated with normalized values, the global ingredient database may also or instead be populated with attribute names that receiving entities have defined for various ingredients (referred to by this specification as “global attributes”), and/or names of suppliers that receiving entities are using to supply various ingredients. This information is independently useful for naïve users of an ingredient, who may not know where to source an ingredient, or know what attributes others are monitoring in their shipments of an ingredient.

A user's selection of an ingredient, a supplier entity, or an attribute is received (905), and one or more of the normalized values that are associated with the selected ingredient, supplier entity, or attribute in the global ingredient database are aggregated (906). The user may be a customer which has or does not have an existing business relationship with the supplier entity, the supplier entity itself, or another supplier entity.

If the user selects an ingredient, the global ingredient database may return a list of attributes that receiving entities have defined for the ingredient, and/or a list of suppliers that supply the ingredient. Alternatively, aggregated normalized values associated with the user-selected ingredient may be provided. The aggregated normalized values may represent many things, such as a supplier's typical deviation from a specification, or a deviation of actual values from stated COA values.

Although the global ingredient database may store raw, actual or expected values, the normalized values themselves are not raw values. Rather, the normalized values are values that represent an extent to which a supplier has deviated from a specification or expectation. For instance, the normalized values may be correlation values, or a “Z-score.”

A representation of the aggregated values is provided to the user (907), thereby ending the process 900 (909). The representation may be color coded to aid the analysis of the recipient. The representation of the normalized values that is output to the user may include the raw normalized values themselves, an analysis of the normalized values, or some other indicator of the meaning of the normalized values. The indicator may be, for example, a color coded indicator with, e.g., a green icon for a normalized value that is better than average, and red icon for a normalized value that is worse than average.

The indicator may also include a ranking of the supplier from among all suppliers that supply a particular ingredient, ranked according to an aggregated normalized value associated with each supplier. In some implementations the identities of all of the suppliers may be made available to the user which, in other implementations, the identifies of the suppliers other than the selected supplier may be hidden. The identities of the other suppliers may be made available to the user for an additional fee.

The representation may allow the user to make a business decision regarding the supplier. If the user is a customer, a favorable risk score may mean that the customer sends more business to the supplier, and an unfavorable risk score may mean that the customer sends less business to the supplier. If the user is the supplier, a favorable risk score may serve as a confirmation of its good business practices, while an unfavorable risk score may indicate that quality needs to be better controlled. If the user is a competitor supplier of the supplier, the risk score can be compared with the competitor supplier's own risk score, and appropriate business leads can be developed (in the case of a favorable comparison) or quality can be better monitored (in the case of an unfavorable comparison).

In summary, FIGS. 7 to 10 illustrate example systems and processes for performing inter-enterprise ingredient specification compliance, describing, in particular, a global ingredient database that collects normalized data from multiple customers of a supplier to create a global risk profile for suppliers across ingredients and attributes of ingredients. In doing so, another customer can objectively measure the strengths and weaknesses of a particular supplier based on past interactions between the particular supplier and other customers, without relying on subjective information, and without revealing to the customer information that may be proprietary or sensitive to the other customers.

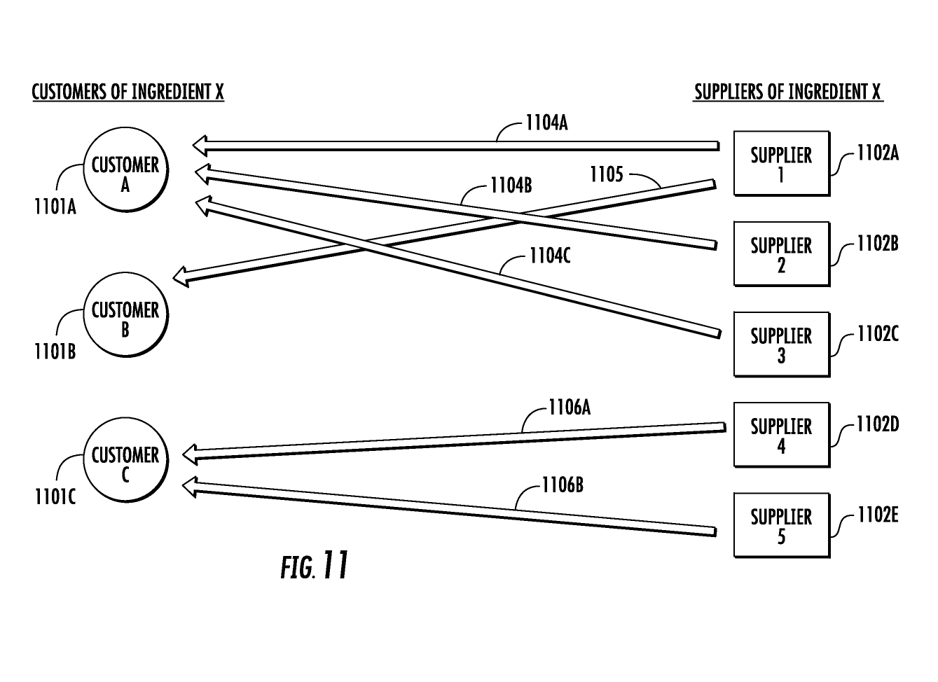

The inter-enterprise and intra-enterprise ingredient specification compliance techniques described in FIGS. 1 to 10 may be used together by enterprises to evaluate suppliers, and to further important business goals. FIG. 11 illustrates several example relationships between customers 1101A-C and suppliers 1102A-E of an ingredient (“Ingredient X”), highlighting several types of information that can be gleaned from these relationships.

As illustrated by arrows 1104A-C, customer 1101A may receive shipments of the ingredient from suppliers 1102A-C. Using the intra-enterprise ingredient specification compliance techniques described in FIGS. 1 to 6, the customer 1101A may measure and evaluate the suppliers 1102A-C against each other based upon specification compliance and risk, enhancing the ability of the customer 1101A to perform strategic sourcing (e.g., to choose the best suppliers in a given situation), and to negotiate with a particular supplier. In renewing a business relationship with one of the suppliers 1102A-C, for instance, the customer 1101A can use hard data that indicates how well the supplier has lived up to its promises in the past, as leverage for negotiating more favorable business terms. If the hard data is favorable to the supplier, the supplier may use this data in a similar manner.

Using the inter-enterprise ingredient specification, the customer 1101A may compare and rank the suppliers 1102A-C against each other and, using information stored in the global ingredient database, against the suppliers 1102D-E. Such a comparison may allow the customer 1101A to evaluate hard data that reflects the extent to which each of the suppliers 1102A-C are living up to their promises in relation to how well other suppliers (including suppliers with which customer 1101A has no business relationship) are living up to their promises. Such information improves the customer's alternative sourcing capabilities and options. For instance, the customer 1101A may use this data to decide to terminate a relationship with one of the suppliers 1102A-C in favor of establishing a relationship with one of the suppliers 1102D-E.

Furthermore, customer 1101B may have an ongoing business relationship with supplier 1102A, as indicated by arrow 1105. The customer 1101B may look to expand its business relationships beyond this one supplier, and my rank the supplier 1102B against the suppliers 1102B-E using the normative values retrieved from the global ingredient database. Similar to the above example, such information may enhance the customer's alternative sourcing capabilities and negotiating position.

Moreover, as indicated by arrows 1106A-B, the suppliers 1102D-E may supply the ingredient to the customer 1101C. The supplier 1102D may compare and rank its performance against other suppliers using information retrieved from the global ingredient database, and use this analysis to negotiate more favorable business terms with the customer 1101C. If the customer 1101C is the supplier's only customer, the supplier 1102D may use this information to decide whether to consider expanding their sales activities.

A number of implementations have been described. Nevertheless, it will be understood that various modifications may be made without departing from the spirit and scope of the disclosure. For example, various forms of the flows shown above may be used, with steps re-ordered, added, or removed.

Embodiments and all of the functional operations described in this specification can be implemented in digital electronic circuitry, or in computer software, firmware, or hardware, including the structures disclosed in this specification and their structural equivalents, or in combinations of one or more of them. Embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments have been described. Other embodiments are within the scope of the following claims. For example, the steps recited in the claims can be performed in a different order and still achieve desirable results.

What is claimed is:

1. A computer-implemented method comprising:
obtaining one or more normalized values that reflect an extent to which a supplier entity has satisfied an expectation of a receiver entity;
populating a global ingredient database that references different ingredients, and different supplier entities and attributes associated with each ingredient, with the normalized values;
receiving a user's selection of an ingredient, a supplier entity, or an attribute;
aggregating one or more of the normalized values that are associated with the selected ingredient, supplier entity, or attribute in the global ingredient database; and
outputting a representation of the aggregated values to the user.

2. The method of claim 1, wherein the normalized values reflect an extent to which the supplier entity has deviated from a specification value.

3. The method of claim 2, wherein each normalized value reflects an extent to which the supplier entity has deviated from a specification value for an attribute of the ingredient.

4. The method of claim 1, wherein the normalized values reflect an extent to which the supplier entity's reported values match third party assessed values.

5. The method of claim 1, wherein the normalized values reflect an extent to which the supplier entity has satisfied on-time information requests from the receiver entity.

6. The method of claim 1, comprising:
receiving one or more actual values and one or more expected values; and
generating the one or more normalized values using the actual values and the expected values.

7. The method of claim 1, wherein the user comprises the receiver entity.

8. The method of claim 1, wherein the user comprises a different receiver entity with which the supplier entity does not have an existing business relationship.

9. The method of claim 1, wherein the user comprises the supplier entity.

10. The method of claim 1, wherein the user comprises a competitor of the supplier entity.

11. The method of claim 1, wherein the user comprises a third party that is not the supplier entity or a competitor of the supplier entity, and is not the receiver entity.

12. A system comprising:
one or more computers; and
a computer-readable medium coupled to the one or more computers having instructions stored thereon which, when executed by the one or more computers, cause the one or more computers to perform operations comprising:
obtaining one or more normalized values that reflect an extent to which a supplier entity has satisfied an expectation of a receiver entity;
populating a global ingredient database that references different ingredients, and different supplier entities and attributes associated with each ingredient, with the normalized values;
receiving a user's selection of an ingredient, a supplier entity, or an attribute;
aggregating one or more of the normalized values that are associated with the selected ingredient, supplier entity, or attribute in the global ingredient database; and
outputting a representation of the aggregated values to the user.

13. The system of claim 12, wherein the normalized values reflect an extent to which the supplier entity has deviated from a specification value.

14. The system of claim 13, wherein each normalized value reflects an extent to which the supplier entity has deviated from a specification value for an attribute of the ingredient.

15. The system of claim 12, wherein the normalized values reflect an extent to which the supplier entity's reported values match third party assessed values.

16. The system of claim 12, wherein the normalized values reflect an extent to which the supplier entity has satisfied on-time information requests from the receiver entity.

17. The system of claim 12, wherein the operations comprise:
receiving one or more actual values and one or more expected values; and
generating the one or more normalized values using the actual values and the expected values.

18. The system of claim 12, wherein the user comprises the receiver entity.

19. The system of claim 12, wherein the user comprises a different receiver entity with which the supplier entity does not have an existing business relationship.

20. The system of claim 12, wherein the user comprises the supplier entity.

21. The system of claim 12, wherein the user comprises a competitor of the supplier entity.

22. The system of claim 12, wherein the user comprises a third party that is not the supplier entity or a competitor of the supplier entity, and is not the receiver entity.

23. A computer storage medium encoded with a computer program, the program comprising instructions that when executed by data processing apparatus cause the data processing apparatus to perform operations comprising:
obtaining one or more normalized values that reflect an extent to which a supplier entity has satisfied an expectation of a receiver entity;
populating a global ingredient database that references different ingredients, and different supplier entities and attributes associated with each ingredient, with the normalized values;
receiving a user's selection of an ingredient, a supplier entity, or an attribute;
aggregating one or more of the normalized values that are associated with the selected ingredient, supplier entity, or attribute in the global ingredient database; and
outputting a representation of the aggregated values to the user.

24. The medium of claim 23, wherein the normalized values reflect an extent to which the supplier entity has deviated from a specification value.

25. The medium of claim 24, wherein each normalized value reflects an extent to which the supplier entity has deviated from a specification value for an attribute of the ingredient.

26. The medium of claim 23, wherein the normalized values reflect an extent to which the supplier entity's reported values match third party assessed values.

27. The medium of claim 23, wherein the normalized values reflect an extent to which the supplier entity has satisfied on-time information requests from the receiver entity.

28. The medium of claim 23, wherein the operations comprise:
receiving one or more actual values and one or more expected values; and
generating the one or more normalized values using the actual values and the expected values.

29. The medium of claim 23, wherein the user comprises the receiver entity.

30. The medium of claim 23, wherein the user comprises a different receiver entity with which the supplier entity does not have an existing business relationship.

31. The medium of claim 23, wherein the user comprises the supplier entity.

32. The medium of claim 23, wherein the user comprises a competitor of the supplier entity.

33. The medium of claim 23, wherein the user comprises a third party that is not the supplier entity or a competitor of the supplier entity, and is not the receiver entity.
